(19) United States
(12) Patent Application Publication
(10) Pub. No.: US 2003/0049184 A1
(43) Pub. Date: Mar. 13, 2003

(54) Methanol reforming apparatus

(75) Inventors: Fumikazu Kimata, Hamakita-shi (JP); Nobutoshi Konagai, Hamamatsu-shi (JP); Kosei Yamamoto, Hamamatsu-shi (JP)

Correspondence Address: GREENBLUM & BERNSTEIN, P.L.C., 1950 ROLAND CLARKE PLACE, RESTON, VA, 20191, US

(73) Assignee: SUZUKI MOTOR CORPORATION, Shizouka-ken (JP)

(21) Appl. No.: 10/234,239

(22) Filed: Sep. 5, 2002

(30) Foreign Application Priority Data
Sep. 12, 2001 (JP) 2001-275912

(51) Int. Cl. B01J 8/04; F28D 21/00

(52) U.S. Cl. 422/188; 422/193; 422/198

(57) ABSTRACT

A compact, highly efficient methanol reforming apparatus is provided in which a CO concentration in a reformed gas can be decreased during load fluctuations below the concentration allowable for fuel cells. A reforming device of the methanol reforming apparatus is formed from a stacked structure of flat sheets. The reforming device includes evaporation and preheating sections for evaporating and preheating the reforming fuel and a reforming section provided with a combustion catalyst accelerating the reaction of reforming fuel which is methanol. Further, an oxidation section for oxidizing CO as a byproduct generated in the reforming section is provided downstream of the reforming section. A sensor is provided in the oxidation section, and air for CO oxidation section cooling is appropriately supplied thereto.

### BACKGROUND OF THE INVENTION

1. Field of the Invention

The present invention relates to a compact methanol reforming apparatus in which fuel hydrogen necessary for fuel-cell electric automobiles can be generated with a high efficiency and carbon monoxide (CO) concentration is sufficiently decreased.

2. Description of the Related Art

When hydrogen is generated by steam reforming of methanol, the reaction is endothermic. Furthermore, if a copper-containing catalyst is used for steam reforming of methanol, the reaction usually has to be conducted at a temperature of 250 to 350° C. For this purpose, heat has to be supplied to the reforming starting gas or reforming catalyst. Stacked reforming devices have been suggested in which combustion chambers for combustion of methanol or off-gas from fuel cells induced by combustion catalysts and reforming chambers for conducting the reforming reaction were alternately stacked via partitions and combustion heat was effectively supplied to the reforming reaction as a method for such heating.

In addition to hydrogen (H₂) and carbon monoxide (CO₂), about 1% CO is contained as a byproduct in the reformed gas. However, Pt (Platinum) catalysts used in anodes of fuel cell stacks are poisoned and the output of cells is greatly decreased if CO is contained in the reformed gas. Therefore, the CO concentration should be made as low as possible. Because the reformed gas is usually released from the reforming device at a temperature of 250 to 300° C., the reformed gas has to be cooled to a temperature suitable for CO oxidation.

Further, if the reaction temperature becomes too low, the CO conversion ratio of the catalysts used for the CO selective oxidation reaction decreases, and if the temperature becomes too high, the CO conversion ratio is decreased and also methanol is produced by the reaction of hydrogen and CO present in the reformed gas. Therefore, the temperature should be accurately controlled for an optimum range (110 to 120° C.).

Japanese Laid-open Patent Application No. H11-228103 and Japanese Patent Application No. 2000-154001 suggested a stacked reforming device provided with a CO oxidation section. However, since the temperature of the entire reforming system can be controlled only under steady-state conditions, when the reforming device is installed on fuel-cell electric automobiles, which operate with significant load fluctuations caused by acceleration and deceleration, and flow rates of reforming and combustion fuel fluctuate, there is a possibility that the temperature of the CO oxidation section will shift from the temperature range suitable for the reaction and the CO concentration will not be decreased sufficiently.

Furthermore, Japanese Patent Application No. 2000-323162 disclosed a reforming system provided with a function of cooling the reformed gas. However, in this system, a heat exchanger for cooling and CO oxidation section are separated from the reforming section, thereby enlarging the apparatus. Moreover, since the apparatus is composed of a large number of parts, the apparatus and installation thereof are complex, which results in increased cost and makes the production difficult.

### SUMMARY OF THE INVENTION

With the foregoing in view, it is an object of the present invention to provide a compact and highly efficient methanol reforming apparatus in which a CO selective oxidation apparatus is incorporated in a stacked structure of a stacked reforming device having excellent thermal efficiency and the temperature of CO oxidation section is accurately controlled making it possible to decrease the CO concentration in the reformed gas to less than the allowable concentration for fuel cells during load fluctuations.

In accordance with the present invention, in order to attain the above-described object, in the methanol reforming apparatus with a stacked structure of flat sheets, having a combustion section provided with a combustion catalyst and a reforming section provided with a catalyst for inducing the reaction of reforming fuel and producing hydrogen and carbon dioxide and also having passages communicating with the combustion section and passages communicating with the reforming section, there is provided an oxidation section for oxidizing carbon monoxide as a byproduct generated in the reforming section into carbon dioxide.

In the flat sheets in accordance with the present invention, thin sheets having a plurality of pairs of passages, and spacers provided with fluid channels partitioned by the thin sheets and having an inlet and an outlet communicating with any pair of passages are stacked alternately, thereby forming the combustion section, reforming section, and oxidation section having the channels, thin sheets having the plurality of passages and thin sheets in which one passage of the pair of passages is closed are used as the thin sheets having a plurality of passages, spacers in which the inlet and outlet of the channel communicate with a pair of passages of the thin sheet and spacers in which one of the inlet and outlet of the channel communicates with any one passage other than the pair of passages are used as the spacers, those thin sheets with different passages and spacers with different inlets and outlets of the fluid channels are appropriately selected and the flow of fluid passing through the combustion section, reforming section, and oxidation section can be controlled.

Further, a channel for cooling air can be provided in the oxidation section to control the oxidation section in accordance with the present invention for a temperature appropriate for a carbon monoxide oxidation reaction. The oxidation section can be arranged downstream of the reforming section.

Moreover, in accordance with the present invention, the cooling air used for cooling the oxidation section can be utilized as air for methanol combustion, after the air of the oxidation section has been cooled, and the heat of the fluid that has passed through the reforming section can be used for heating the reforming fuel evaporation section.

### BRIEF DESCRIPTION OF THE DRAWINGS

The present invention will be better understood from the description of the preferred embodiments of the invention set forth below together with the accompanying drawings, in which:

FIG. 1 is an exploded perspective view showing and embodiment of a methanol reforming apparatus of a basic stack type according to the present invention;

FIG. 2 is a sectional view showing a condition in which the reforming device illustrated in FIG. 1 is placed in a thermally insulating vacuum container;

FIG. 3 is a flow diagram of gases in the integrated reforming device including a reforming section, evaporation and preheating sections, and a CO oxidation section in the embodiment of the present invention;

FIG. 4 is an exploded perspective view showing how the reformed gas and air for CO oxidation section cooling flow through the thin metal sheets and spacers in the CO oxidation section shown in FIG. 3;

FIG. 5 is a flow diagram of gases relating to a case in which the reforming device shown in FIG. 3 is modified and the reformed gas is used for heating the evaporation section and preheating section;

FIG. 6 is a plan view of a thin metal sheet in which all of a plurality of gas passage openings described in the embodiments of the present invention are open;

FIG. 7 is a plan view of the thin metal sheet illustrated in FIG. 6 in which one of a plurality of gas passage openings is closed;

FIG. 8 is an exploded perspective view of thin metal sheets illustrating the flow of reforming fuel and reformed gas in the case of using the thin metal sheet shown in FIG. 7, in which one gas passage opening is closed, and the thin metal sheets shown in FIG. 6 in which all of the gas passage openings are open;

FIG. 9 is a plan view of a basic spacer in which slits are formed as the gas channels used in the embodiments of the present invention;

FIG. 10 is a plan view of a spacer with a different position of an outlet slit in which the orifice communicating with the passage opening is modified with respect to the slit shown in FIG. 9;

FIG. 11 an exploded perspective view of spacers and thin metal sheets illustrating the flows of reforming fuel and reformed gas in the case where the spacer with a different position of outlet slit shown in FIG. 10 and a spacer of the basic shape shown in FIG. 9 are used; and

FIG. 12 is a perspective view of upper and lower pressure plates sandwiching the spacers and thin metal sheets used in the embodiments of the present invention.

### DESCRIPTION OF THE PREFERRED EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description is taken with the drawings making apparent to those skilled in the art how the forms of the present invention may be embodied in practice.

The methanol reforming apparatus in the embodiment of the present invention will be described hereinbelow with reference to the appended drawings.

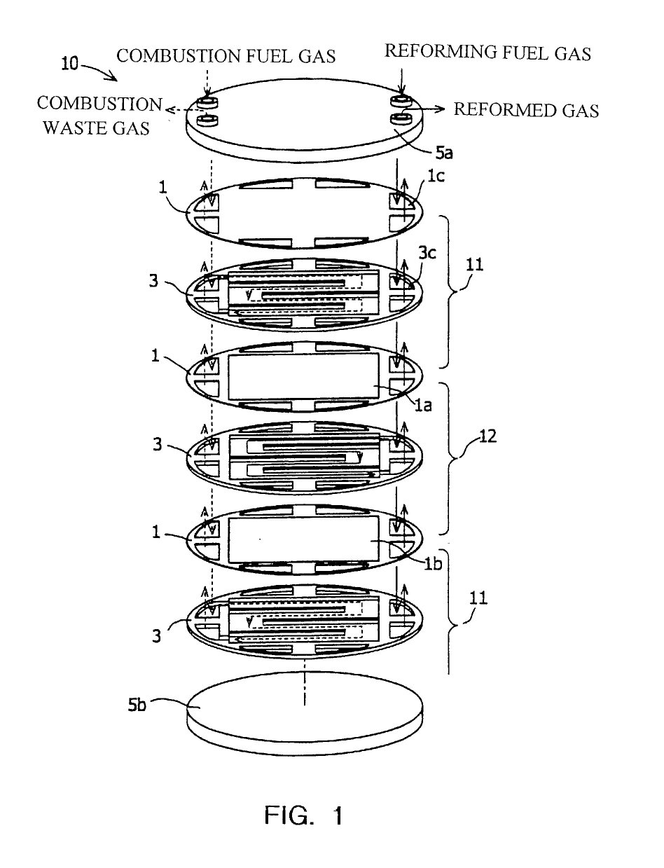

FIG. 1 shows the basic structure of a reforming device of the stack-type methanol reforming apparatus. In this apparatus, a reforming device 10 having a combustion section 11 and a reforming section 12 is formed by alternately stacking any number of thin metal sheets 1 having a plurality of fluid passages 1c and coated with a combustion catalyst 1a on one side and with a reforming catalyst 1b on the other side and a plurality of spacers 3 having slit-like channels bent at an angle.

More specifically, four pairs of passages 1c are provided with a 90° spacing in point-symmetrical positions on the outer periphery of the round thin sheet 1, and on the front and rear surfaces in the central zone of the thin sheet 1 which have no passages, the combustion catalyst 1a is attached to one surface and the reforming catalyst 1b is attached to the other surface. On the other hand, in the spacer 3, passages 3c are formed in positions corresponding to those in the thin sheet 1 and a slit-like linearly bent channel is provided in the central zone. One end of this channel communicates with any one of the pair of passages, and the other end communicates with the passage on the other side.

Thin metal sheets 1 are stacked and the combustion sections 11 and the reforming sections 12 are provided alternately so that in the combustion section 11 with the combustion catalyst 1a is positioned above and below the channel of a spacer 3, which serves as a combustion chamber, and that in the reforming section 12 with the reforming catalyst 1b is positioned above and below the channel of a spacer 3, which serves as a reforming chamber. Spacers 3 of the same shape are used in the combustion section 11 and the reforming section 12, and independent gas channels, in which combustion gas and reformed gas are not mixed with each other, are formed by changing the orientation of spacers by 180 degrees in the tangential direction. As a result, the reforming device 10 can be fabricated by combining parts of only two types, thin metal sheets 1 and spacers 3, and the number of parts used can be reduced which makes it possible to obtain a low-cost reforming device 10. Furthermore, assembling can be conducted merely by tightening with bolts and nuts and no troublesome process, such as welding, is required, which also allows the cost to be reduced. Another advantage is that the hydrogen generation capacity of the reforming device 10 can be freely varied by increasing or decreasing the number of stacked thin metal sheets 1 and spacers 3.

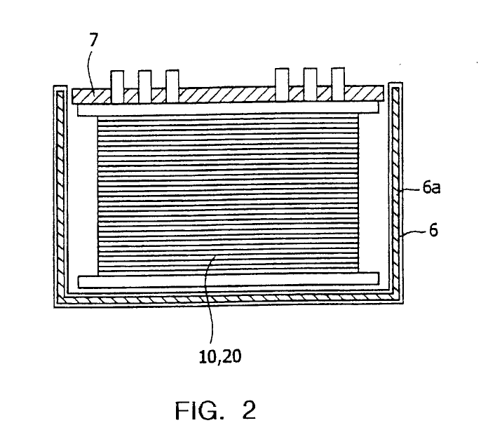

Pressure plates 5a, 5b for preventing leakage of gases are provided on the upper and lower surfaces of the reforming device 10, which plates apply pressure to the alternately stacked thin metal sheets 1 and spacers 3 when tightened with bolts from above and below. As shown in FIG. 2, the stacked reforming device 10 is housed in a stainless steel container 6 having a vacuum thermal insulation layer 6a. The upper part is covered with a thermal insulation material 7 serving as a thermally insulating lid, and loss of heat due to dissipation is greatly reduced, thereby providing for high efficiency of the apparatus.

In accordance with the present invention, evaporation and preheating sections and a CO oxidation section are incorporated integrally into the stacked structure of such basic methanol reforming apparatus, and a CO oxidation section cooling apparatus is also incorporated in the stacked structure so as to decrease the concentration of CO in the reformed gas in the optimum temperature range even in case of load fluctuations. Structures of those sections will be described below in greater detail.

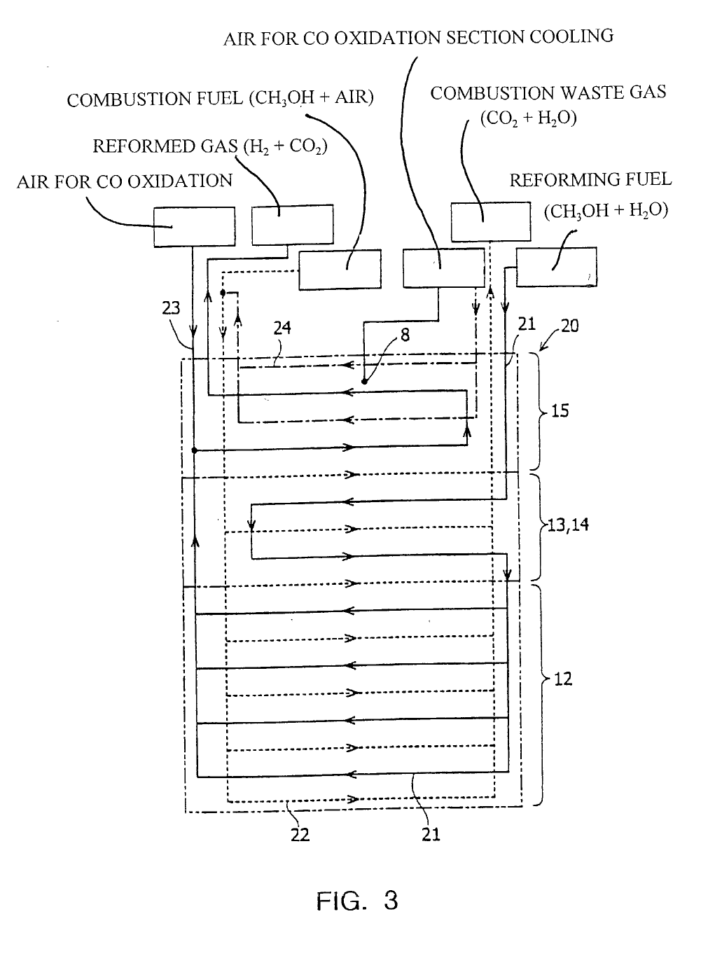

A reformed gas channel 21 where H₂ and CO₂ are obtained by causing the reaction of reforming fuel composed of CH₃OH (methanol) and water is shown in FIG. 3 by a solid line in a reforming device 20 including a reforming section 12, evaporation and preheating sections 13, 14, a CO oxidation section 15, and a CO oxidation section cooling apparatus (not shown). Further, a combustion waste gas channel 22, where combustion fuel consisting of CH₃OH and air is combusted into CO₂ and water, is shown by a broken line. An air channel 23 for CO oxidation is shown by a solid line, and an air channel 24 for CO oxidation section cooling is shown by a dash-dot line.

The CO oxidation section 15 is arranged at the very top of the stacked structure. The evaporation and preheating sections 13, 14 are arranged below it, and the reforming section 12 with the highest temperature is arranged in the lowermost position. The reforming device 20 is configured so that the temperature rises in the direction from the top down. As a result a temperature distribution is obtained which allows for effective utilization of thermal energy.

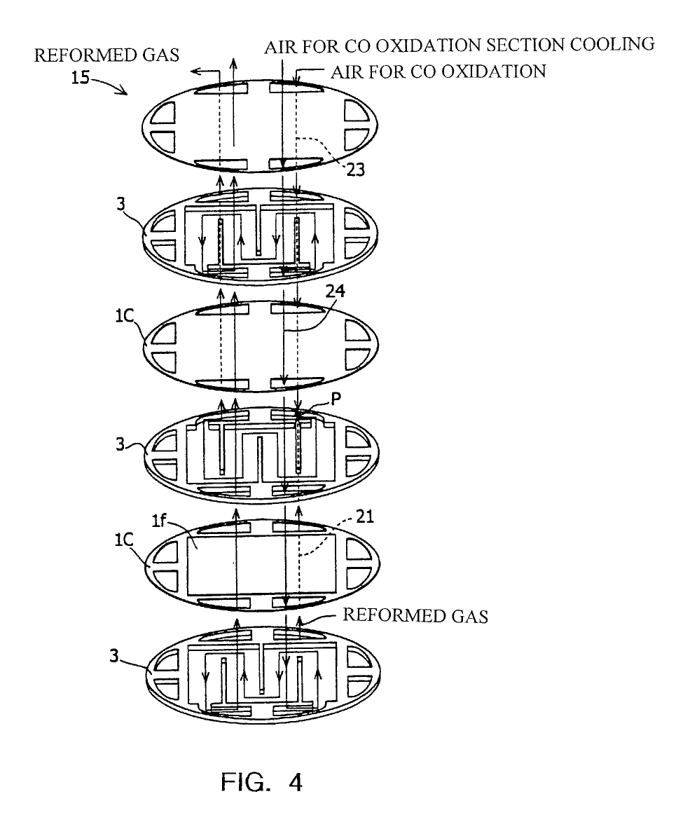

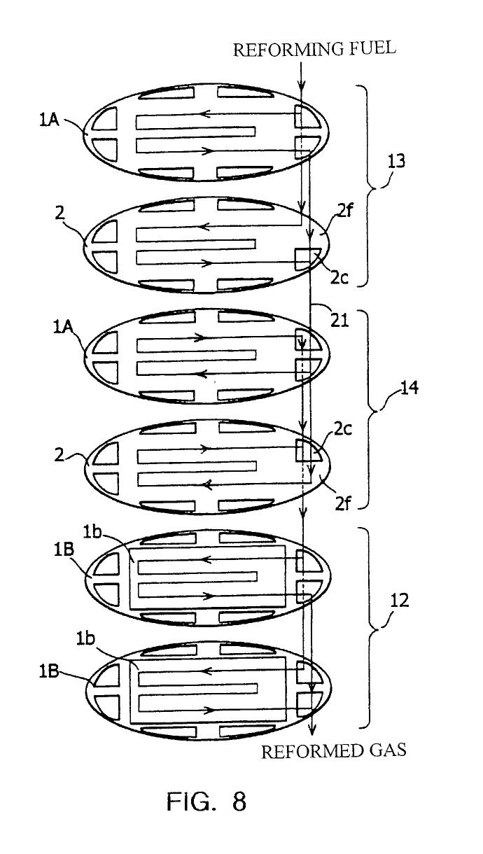

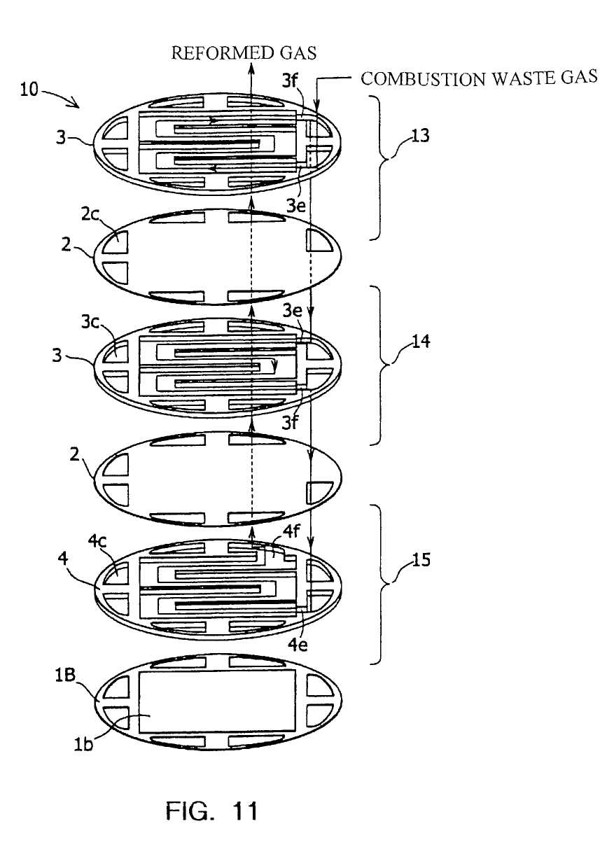

Water and methanol are introduced as reforming fuel in a liquid state into the evaporation and preheating sections 13, 14 located inside the reforming device 20. Heat generated by the combustion reaction in the combustion section 11 is transferred to the evaporation and preheating sections 13, 14 via a thin metal sheet, and the reforming fuel is evaporated and preheated to a temperature (not less than 250° C.) suitable for the reforming reaction. The preheated reforming fuel is introduced into the reforming section 12 where the reforming reaction is catalyzed by the reforming catalyst 1b. In the reforming section 12, the reaction heat obtained in the combustion section 11 is supplied via thin metal sheets 1B (see FIGS. 8 and 11) to the reforming reaction which is an endothermic reaction, and the reforming reaction proceeds at a high reaction ratio. The reformed gas is returned to the top portion of reforming device 20 by a spacer 4 with a different outlet slit position (see FIG. 11). In the course of return to the upper part, air for CO oxidation is supplied via the channel 23 from the air inlet opening in the upper surface of the reforming section 12, mixed with the reformed gas supplied from the channel 21 and introduced in the CO oxidation section 15. In the CO oxidation section 15, the reformed gas is cooled by cooling air via thin metal sheets 1C (see FIG. 4), the reformed gas temperature is controlled in a temperature range (110 to 120° C.) optimum for the reaction, and the CO concentration in the reformed gas is substantially decreased by the CO oxidation catalyst 1f. During load fluctuations, the flow rate of introduced air is controlled by signals from a temperature sensor 8 provided in the CO oxidation section, and the CO oxidation section 15 is controlled for the optimum temperature.

Furthermore, since the air used for cooling holds heat, it is supplied to the air channel 22 for methanol (CH₃OH) combustion and reused, thereby increasing thermal efficiency of the entire reforming system.

FIG. 4 shows a specific example of the reformed gas channel 21, the air channel 23 for CO oxidation, and the air channel 24 for the CO oxidation section cooling in the CO oxidation section 15. The reformed gas released upwardly from the reforming section 12 merges at a merging point P into the channel 23 for air for CO oxidation, which is supplied from the air inlet opening in the upper surface of the reforming section 12 located in the gas channel 21, and is introduced into the CO oxidation section 15. In the CO oxidation section 15, thin metal sheets 1C are used which are coated on only one side with the CO selective oxidation catalyst 1f, and the thin metal sheets 1C are stacked so that the CO selective oxidation catalyst 1f is located above and below the spacer 3 where the reformed gas flows. No specific limitation is placed on the CO selective oxidation catalyst 1f, provided that it is active and selective with respect to the CO selective oxidation reaction. However, catalysts of Ru (Ruthenium) system or Pt (Platinum)/Ru system are preferred.

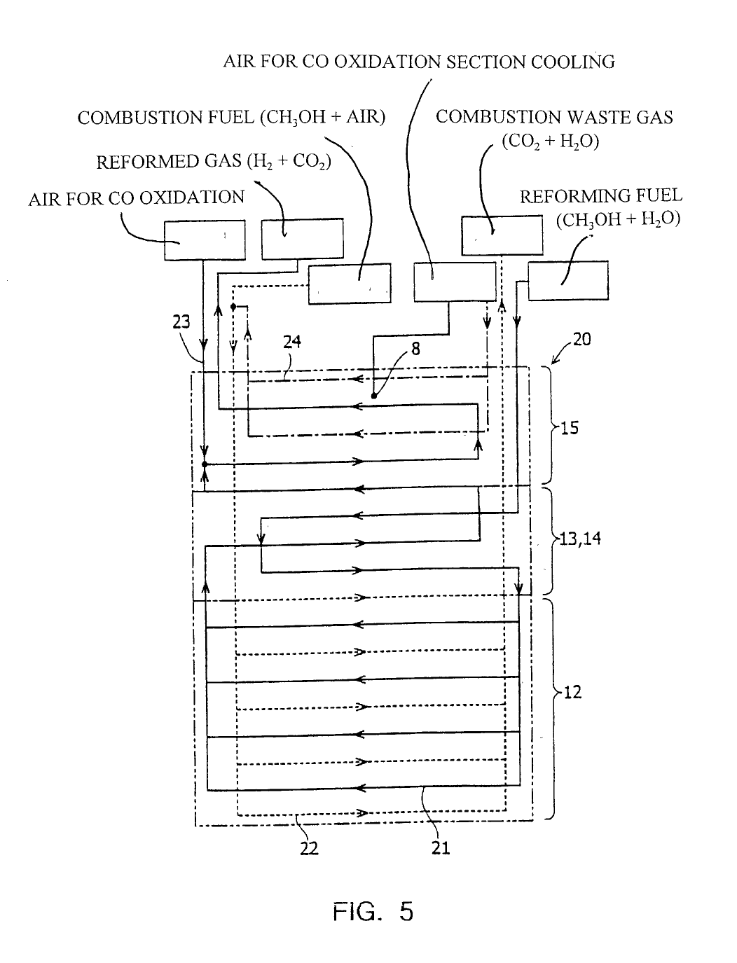

In the CO oxidation section 15, the reformed gas is cooled with the cooling air via thin metal sheets 1C and controlled for a temperature range (110 to 120° C.) optimum for the reaction. Once the CO concentration in the reformed gas has been decreased by using the CO oxidation catalyst 1f, the reformed gas is released upwardly and supplied to a fuel cell stack. Further, a temperature sensor 8 (FIG. 5) can be provided in the CO oxidation section 15, the flow rate of air introduced in response to a signal from the sensor 8 can be controlled, and the CO oxidation section 15 can be controlled for an optimum temperature even during load fluctuations.

Furthermore, the optimum temperature of CO oxidation reaction is within a range of 110 to 120° C., whereas the reformed gas leaves the reforming section 12 at a high temperature of 250 to 300° C. Therefore, the heat of the reforming gas can be used as a heat source for the evaporation and preheating sections 13, 14 and thermal efficiency of the entire reforming system can be increased. FIG. 5 shows flows of each gas when the reformed gas is used for heating the evaporation and preheating sections 13, 14.

If heat supply to the evaporation and preheating sections 13, 14 depends entirely on the reforming gas, the reforming fuel cannot be evaporated when the apparatus is started. Therefore, a combustion section 11 (FIG. 1) must be stacked in the evaporation and preheating sections 13, 14 to a degree necessary for starting.

Structural components of the reforming device 20 employed in accordance with the present invention will be described below in greater detail.

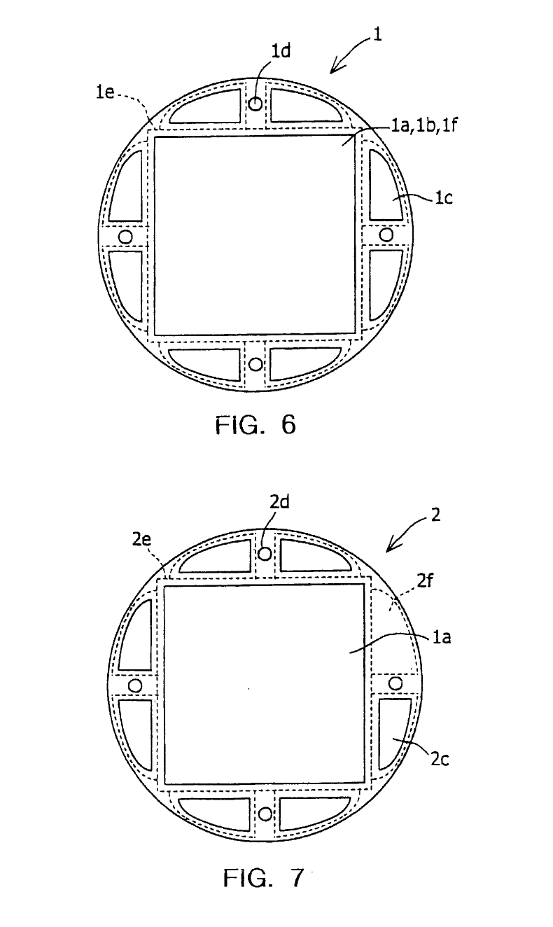

FIG. 6 is an enlarged view of a metal thin sheet 1 in which all of the gas passage openings 1c are open. FIG. 7 is an enlarged view of a thin metal sheet 2 in which one of gas passage openings 2c (2f) is closed.

In the evaporation and preheating sections 13, 14, the combustion catalyst 1a is coated only on one side in the central portion of thin metal sheet 1. This thin metal sheet 1 is denoted by a reference numeral 1A (FIG. 8). In the reforming section 12, the combustion catalyst 1a is coated on one surface, and the reforming catalyst 1b is coated on the other surface. This thin metal sheet 1 is denoted by a reference numeral 1B. In the CO oxidation section 15, the CO selective oxidation catalyst 1f is coated on one side only. This thin metal sheet 1 is denoted by a reference numeral 1C (those thin metal sheets 1A-1C will be simply referred to as a thin metal sheet 1). Respective bolt holes 1d are formed between pairs of passage openings 1c.

On the other hand, in the central portion of thin metal sheet 2, the combustion catalyst 1a is coated on one side only. As shown in FIG. 7, seven passage openings 2c for passing the combustion fuel gas, combustion waste gas, reforming fuel, reformed gas, air for CO oxidation, and air for CO oxidation section cooling are provided around the catalyst-coated portion. In the thin metal sheet 2, there is a portion 2f where one passage opening 2c for gas is closed. Bolt holes 2d for tightening with bolts from above and below are formed between the pairs of passage openings 2c of the thin metal sheet 2 and between the passage openings 2c and the portion 2f where one passage opening 2c for gas is closed. Furthermore, beads 1e, 2e, which may be formed unitarily with the thin metal sheets 1, 2 as raised projections, are attached in the positions shown by broken lines in FIGS. 6 and 7 around the catalyst-coated portions 1a, 1b, the passage openings 1c, 2c, and the portion 2f where one passage opening 2c for gas is closed, and an apparatus exhibiting no gas leakage can be assembled by merely tightening with bolts and nuts from above and below. In order to improve thermal conductivity, it is preferred that sheets with a small thickness (for example, 0.2 mm) be used for the thin metal sheets 1, 2. Moreover, considering their strength, heat resistance, and corrosion resistance at a temperature close to 300 to 400° C., stainless steel sheets are most preferred, although sheets formed of any suitable material may be utilized. It is even more preferred that in order to improve the efficiency of thermal conductivity, the thickness of thin stainless steel sheets be no greater than 0.5 mm.

FIG. 8 shows flows of various gases in the evaporation section 13, the preheating section 14, and the reforming section 12 observed when the thin metal sheet 2 is used in which one gas passage opening 2c is closed.

For ease of understanding the figure, only the thin metal sheets 1 of the evaporation section 13, the preheating section 14, and the reforming section 12 and the channel 21 for the reforming fuel and the reformed gas are shown. In fact, spacers 3 are present between the thin metal sheets 1, and the combustion sections 11 are present between the layers, but those components are omitted for ease of explanation.

The reforming fuel introduced into the evaporation section 13 is introduced as far as the portion 2f where one passage opening 2c for gas of the thin metal sheet 2 is closed, and branches therefrom into two systems. It is then evaporated in the thin metal sheet 1A located above the thin metal sheet 2 and on the thin metal sheet 2 (on upper surface thereof), merging in the passage opening 2c.

The evaporated reforming fuel is released from the passage opening 2c of thin metal sheet 2, which communicates with the spacer outlet slit for the evaporation section 13. The reforming fuel outlet of the evaporation section 13 serves as an inlet of the preheating section 14, and the preheating section 14 is formed in a similar manner up to the layer of the next thin metal sheet 2 where it communicates with the downstream reforming section 12. In the configuration shown in the figure, one thin metal sheets 2 with one closed gas passage opening is provided for every two layers. However, the number of stacked spacers 3 and thin metal sheets 1, 2 can be changed freely. For example, when a plurality of thin metal sheets 1A, 2 are combined in the evaporating section 13, the flows can branch into two systems in the same manner in the next thin metal sheets 1A, 2 and can be merged in the next passage opening 2c.

Further, the length of gas channel 21 can be extended by using only the thin metal sheets 2 with one closed gas passage opening 2c in each section of the evaporation section 13, the preheating section 14, and the reforming section 12. For example, if a plurality of thin metal sheets with one closed gas passage opening are used in the reforming section 12 and gas channels are arranged in series and form one system, rather than being branched as described above into two systems, then the length of the gas passage is enlarged and the contact interval (time) of the fuel gas and the catalyst is increased which makes it possible to raise the reforming efficiency.

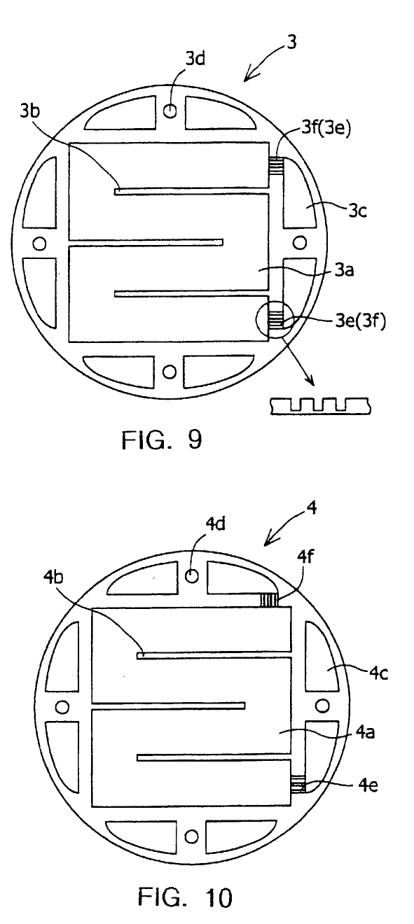

Further, turning the outlet slits of spacers in the reforming section 12 back to the inlet side by changing the position thereof allows the reformed gas to be released in the direction of the inlet side (upper surface) and the reforming device 20 to be housed in the stainless steel container 6 having the vacuum thermal insulation layer 6a shown in FIG. 2 in order to prevent heat dissipation to the outside. FIGS. 9 and 10 are enlarged views of spacers 3, 4 of two types that differ in the outlet slit position.

Spaces 3a, 4a of about the same shape as the catalyst-coated portions of thin metal sheets 1 are provided in the central portion of those spacers 3, 4. Further, providing protruding portions 3b, 4b causes the channel to follow an almost S-like circuitous path, thereby increasing the length of gas passage. As a result, thermal exchange efficiency of the combustion section 11, the evaporation and preheating sections 13, 14, and the reforming section 12 is improved. Bolt holes 3d, 4d for tightening the gas passages 3c, 4c, which have the same shape as those in thin metal sheets 1, with the bolts from above and below are further provided around the spaces 3a, 4a in the central portion serving as the gas channel.

Inlet slits 3e, 4e and outlet slits 3f, 4f having a cross section including peaks and valleys are provided in the spacers 3, 4, those slits connecting the space 3a of the central catalyst portion and gas passages 3c. Forming a slit-like shape makes it possible to tighten the spacers 3, 4 and thin metal sheets 1, 2 even in the inlet and outlet zones and prevent gas leakage.

One spacer 4 of the spacers 3, 4 is provided with the outlet slit 4f in the position of gas passage opening that is not employed as the gas passage opening 4c when only spacer 3 is used. The thickness of spacers 3, 4 is preferably about 0.5 to 5 mm. If the thickness is too small, passage of gas is degraded and gas pressure rises or the gas flow becomes nonuniform. If the thickness is too large, unreacted gas appears or volume and weight are increased. Any material that can be used at a temperature close to 300 to 400° C. is suitable for spacers 3, 4. Thus, stainless steel or copper can be used. With weight decrease in mind, aluminum and titanium can be considered.

FIG. 11 shows the reformed gas flow in the reforming device 20 using the spacer 4 with a modified position of the outlet slit 4f. Connecting the outlet slit 4f to that gas passage opening 4c of a plurality of passage openings 4c which is not used in other passages allows the gas to be returned to the upper surface in the same direction as that of the fuel inlet and the device to be housed in a container having a vacuum thermal insulation layer. As a result, loss of heat to the outside due to heat dissipation is suppressed, thereby providing for a highly efficient apparatus.

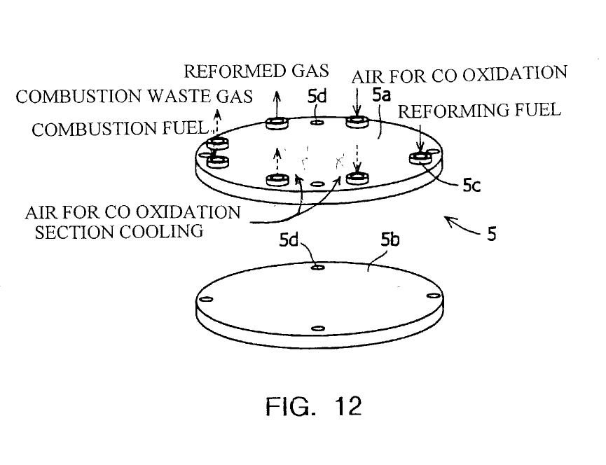

The upper and lower surfaces of the reforming device 20 are provided with pressure plates 5a, 5b, as shown in FIG. 12, in order to tighten the alternately stacked thin metal sheets 1, 2 and spacers 3, 4 from the top and the bottom with bolts and to prevent leakage of gases. The pressure plate 5a on the upper surface is provided with passage openings 5c for passing the combustion fuel, combustion waste gas, reforming fuel gas, reformed gas, air for CO oxidation, and air for CO oxidation section cooling (not shown). The passage openings 5c can be provided in any position so as to match the gas passage openings 1c, 2c of the spacers 3, 4 and the thin metal sheets 1, 2.

Bolt holes 5d for tightening with bolts from above and below are provided in the pressure plates 5a, 5b on the upper and lower surfaces. In accordance with the present invention, as shown in FIG. 2, the stacked reforming device 20 is housed in the stainless steel container 6 having the vacuum thermally insulating layer 6a, and loss of heat to the outside caused by heat dissipation is suppressed, which provides for a high efficiency of the apparatus. Arranging the ceramic thermally insulating material 7 on top of the reformer 20 suppresses heat dissipation through the top.

As described above, the reforming device 20 in which all of the components, that is, the reforming section, the combustion section, the evaporation and preheating sections, the CO oxidation section, and CO oxidation section cooling apparatus (not illustrated) are integrated, can be fabricated and the low-cost reforming device 20 with a small number of parts can be obtained by combining parts of four types composed of two types of thin metal sheets, which differ only in whether one of the gas passage openings is closed, and two types of spacers which differ only in the position of outlet slits. Furthermore, the cost is reduced and productivity is high also because the assembly of the reforming device 20 can be conducted merely by tightening with bolts and requires no troublesome operation such as welding. Moreover, varying the number of thin metal sheets and spacers in the stack makes it possible to change freely the hydrogen generation capacity of the reforming devices 10, 20.

### EXAMPLE

One example of the structure of the reforming device is as follows.

Thin Metal Sheets

Thin sheets of stainless steel SUS301H with an outer diameter of 160 mm and a thickness of 0.2 mm were used.

Evaporation and Preheating Sections

In the evaporation and preheating sections, thin metal sheets coated with a 1-5 wt. % Pt/alumina catalyst as a combustion catalyst on one side and having no coating on the other side were used.

Reforming Section

In the reforming section, thin metal sheets coated with a 1-5 wt. % Pt/alumina catalyst as a combustion catalyst on one side and with a reforming catalyst of a Cu—Zn system on the other side were used.

CO Oxidation Section

In the CO oxidation section, thin metal sheets coated with a 1 wt. % Pt—Ru/alumina catalyst as a CO selective oxidation catalyst on one side and having no coating on the other side were used. The surface area of the catalyst coating was 100 mm by 100 mm on one side of one thin metal sheet.

Spacers

Thin sheets of stainless steel SUS304 with an outer diameter of 160 mm and a thickness of 2 mm were used.

A reforming device composed of stacked spacers and thin metal sheets was fabricated. In the device, the CO selective reaction section consisted of 5 layers, the evaporation and preheating sections consisted of 8 layers, the reforming section consisted of 10 layers, and the combustion section consisted of 19 layers.

Pressure plates made from SUS304 and having a thickness of 10 mm were mounted on the top and bottom of the reaction section and secured with bolts and nuts. Furthermore, the reforming device was housed in a stainless steel container having a vacuum thermal insulation layer to reduce loss of heat due to dissipation.

Methanol and air as combustion fuel gases were supplied from the inlet of the combustion section. A reforming fuel composed of methanol and water at a molar ratio of 1:1 was supplied in a liquid state from the inlet of the evaporation section, and air was supplied for CO selective oxidation. In order to decrease the CO concentration sufficiently, the supplied amount of air was 2 to 5 times the necessary amount of air calculated from the CO concentration in the reformed gas. In the test, hydrogen at 40 L/min could be generated with a reforming ratio of 95% at a temperature of reforming section of about 300° C. Furthermore, the CO concentration in the reformed gas could be decreased to 10 ppm by introducing air for CO oxidation section cooling and controlling the temperature of the CO oxidation section for about 115° C.

While embodiments of the present invention have been described hereinabove, the present invention is not limited thereto and various modifications or variations may be made based on the technological concept of the invention.

For example, the method for combining the thin metal sheets and spacers may be selected so as to obtain an optimum size or hydrogen generation capacity of the reforming device and is not limited to the combinations shown in the present invention. Moreover, thin metal sheets and spacers may be integrally formed as units containing one of each, and the units may be stacked.

Dimethyl ether (DME) can be used instead of methanol as a reforming fuel. In this case, since DME is a gas at a normal temperature, the evaporation section is not required.

The efficiency can be further increased by using off-gas (H₂ gas) from fuel cells as a combustion fuel instead of methanol.

With the methanol reforming apparatus of one aspect of the present invention, a methanol reforming apparatus with a stacked structure of flat sheets, having a combustion section provided with a combustion catalyst and a reforming section provided with a reforming catalyst for inducing the reaction of reforming fuel and formation of hydrogen and carbon dioxide is provided. The apparatus includes passages communicating with the combustion section and passages communicating with the reforming section, an oxidation section is provided for oxidizing carbon monoxide as a byproduct generated in the reforming section into carbon dioxide. Therefore, it is not necessary to provide a CO removal apparatus outside of the reforming device, and a compact methanol reforming apparatus can be obtained.

With the methanol reforming apparatus of another aspect of the present invention, an evaporation section for evaporating the reforming fuel is provided in front of the reforming section in the stacked structure. Therefore, methanol and water can be converted into hydrogen and CO₂ with good efficiency and the apparatus is by itself compact.

With the methanol reforming apparatus of a further of the present invention, in the flat sheets, thin sheets having a plurality of pairs of passages, and spacers provided with fluid channels partitioned by the thin sheets and having an inlet and an outlet communicating with any pair of passages, are stacked alternately, thereby forming the combustion section, reforming section, and the oxidation section having the channels. Thin sheets having the plurality of passages and thin sheets in which one passage of the pair of passages is closed are used as the thin sheets having a plurality of passages, and spacers in which the inlet and outlet of the channel communicate with a pair of passages of the thin sheet and spacers in which one of the inlet and outlet of the channel communicates with any one passage other than the pair of passages are used as the spacers. Additionally, the thin sheets with different passages and spacers with different inlets and outlets of the fluid channels are appropriately selected, and the flow of fluid passing through the combustion section, the reforming section, and the oxidation section is controlled. Therefore, the CO oxidation section can be incorporated in the stacked reforming device merely by slightly changing the shape of thin metal sheets and spacers.

With the methanol reforming apparatus of another aspect of the present invention, a channel for cooling air is provided in the oxidation section to control the oxidation section for a temperature appropriate for a carbon monoxide oxidation reaction. Therefore, the CO concentration in the reformed gas can be decreased sufficiently even during load fluctuations.

With the methanol reforming apparatus of still another aspect of the present invention, the oxidation section is arranged downstream of the reforming section. Therefore, the reforming apparatus has a temperature distribution providing for the highest thermal efficiency.

With the methanol reforming apparatus of still another aspect of the present invention, the cooling air used for cooling the oxidation section is utilized as air for methanol combustion, after the air of oxidation section has been cooled, thereby increasing thermal efficiency of the entire system owing to waste heat utilization.

With the methanol reforming apparatus still another aspect of the present invention, heat of the fluid that has passed through the reforming section is used for heating the reforming fuel evaporation section. Therefore, heat efficiency of the entire system can be increased by using waste heat of reformed gas.

Although the invention has been described with reference to an exemplary embodiment, it is understood that the words that have been used are words of description and illustration, rather than words of limitation. Changes may be made, within the purview of the appended claims, as presently stated and as amended, without departing from the scope and spirit of the present invention in its aspects. Although the invention has been described herein with reference to particular means, materials and embodiments, the invention is not intended to be limited to the particulars disclosed herein. Instead, the invention extends to all functionally equivalent structures, methods and uses, such as are within the scope of the appended claims.

The present application claims priority under 35 U.S.C. §119 of Japanese Application No. JP 2001-275912, filed on Sep. 12, 2001, the disclosure of which is expressly incorporated herein by its entirety.

What is claimed is:

1. A methanol reforming apparatus having a stacked structure of thin sheets comprising:
a reforming section for inducing a reaction of a reforming fuel and a formation of hydrogen and carbon dioxide;
a combustion section for supplying reforming heat to said reforming section, said combustion section having a combustion catalyst;
an oxidation section for oxidizing carbon monoxide as a byproduct generated in said reforming section into carbon dioxide;
a plurality of first passages for communicating with said combustion section; and
a plurality of second passages for communicating with said reforming section,
wherein each of said sections are stacked in contact with each other.

2. The methanol reforming apparatus according to claim 1, further comprising:
an evaporation section for said reforming fuel, wherein said evaporation section is provided in front of said reforming section in said stacked structure.

3. The methanol reforming apparatus according to claim 1, wherein said thin sheets comprise a plurality of pairs of passages, and spacers provided with a plurality of fluid channels partitioned by said thin sheets and having an inlet and an outlet communicating with any pair of passages are stacked alternately, thereby forming said combustion section, said reforming section, and said oxidation section having said channels;
said thin sheets having the plurality of passage in which one passage of said pair of passages is closed are used as said thin sheets having the plurality of passages, spacers in which said inlet and said outlet of the channel communicate with a pair of passages of said thin sheets and said spacers in which one of said inlet and said outlet of the channel communicates with any passage other than the pair of passages used as said spacers, whereby said thin sheets with different passages and spacers with different inlets and outlets of the fluid channels are appropriately selected and the flow of fluid passing through said combustion section, said reforming section, and said oxidation section is controlled.

4. The methanol reforming apparatus according to claim 1, further comprising a channel for cooling air, wherein said channel for cooling air is provided in said oxidation section in order to cool said oxidation section to a temperature appropriate for a carbon monoxide oxidation reaction.

5. The methanol reforming apparatus according to claim 1, wherein said oxidation section is arranged downstream of said reforming section.

6. The methanol reforming apparatus according to claim 1, wherein cooling air used for cooling said oxidation section is utilized as the air for the methanol combustion, after the air of said oxidation section has been cooled.

7. The methanol reforming apparatus according to claim 2, wherein a heat of a fluid that has passed through said reforming section is used for heating said reforming fuel evaporation section.

8. The methanol reforming apparatus according to claim 2, wherein said thin sheets comprise a plurality of pairs of passages, and spacers provided with a plurality of fluid channels partitioned by said thin sheets and having an inlet and an outlet communicating with any pair of passages are stacked alternately, thereby forming said combustion section, said reforming section, and said oxidation section having said channels;
said thin sheets having the plurality of passage in which one passage of said pair of passages is closed are used as said thin sheets having the plurality of passages, spacers in which said inlet and said outlet of the channel communicate with a pair of passages of said thin sheets and said spacers in which one of said inlet and said outlet of the channel communicates with any passage other than the pair of passages used as said spacers, whereby said thin sheets with different passages and spacers with different inlets and outlets of the fluid channels are appropriately selected and the flow of fluid passing through said combustion section, said reforming section, and said oxidation section is controlled.

9. The methanol reforming apparatus according to claim 3, further comprising a channel for cooling air, wherein said channel for cooling air is provided in said oxidation section in order to cool said oxidation section to a temperature appropriate for a carbon monoxide oxidation reaction.

10. The methanol reforming apparatus according to claim 2, wherein said oxidation section is arranged downstream of said reforming section.

11. The methanol reforming apparatus according to claim 3, wherein said oxidation section is arranged downstream of said reforming section.

12. The methanol reforming apparatus according to claim 4, wherein said oxidation section is arranged downstream of said reforming section.

13. The methanol reforming apparatus according to claim 2, wherein cooling air used for cooling said oxidation section is utilized as the air for the methanol combustion, after the air of said oxidation section has been cooled.

14. The methanol reforming apparatus according to claim 3, wherein cooling air used for cooling said oxidation section is utilized as the air for the methanol combustion, after the air of said oxidation section has been cooled.

15. The methanol reforming apparatus according to claim 4, wherein cooling air used for cooling said oxidation section is utilized as the air for the methanol combustion, after the air of said oxidation section has been cooled.

16. The methanol reforming apparatus according to claim 5, wherein cooling air used for cooling said oxidation section is utilized as the air for the methanol combustion, after the air of said oxidation section has been cooled.

17. The methanol reforming apparatus according to claim 3, wherein heat of a fluid that has passed through said reforming section is used for heating said reforming fuel evaporation section.

18. The methanol reforming apparatus according to claim 4, wherein heat of a fluid that has passed through said reforming section is used for heating said reforming fuel evaporation section.

19. The methanol reforming apparatus according to claim 5, wherein heat of a fluid that has passed through said reforming section is used for heating said reforming fuel evaporation section.

20. The methanol reforming apparatus according to claim 6, wherein heat of a fluid that has passed through said reforming section is used for heating said reforming fuel evaporation section.
